(19) United States
(12) Patent Application Publication
(10) Pub. No.: US 2014/0285939 A1
(43) Pub. Date: Sep. 25, 2014

(54) BREAKER CIRCUIT WITH FAILURE SELF-DETECTION FUNCTIONS

(71) Applicant: Ze CHEN, Yueqing City (CN)

(72) Inventor: Ze CHEN, Yueqing City (CN)

(21) Appl. No.: 13/946,512

(22) Filed: Jul. 19, 2013

(30) Foreign Application Priority Data
Mar. 22, 2013 (CN) 201310094717.2

(51) Int. Cl. H02H 3/04

(52) U.S. Cl. CPC H02H 3/04
USPC 361/115

(57) ABSTRACT

A breaker circuit is provided with failure self-detection functions. The circuit may comprise line and neutral power supply lines, line and neutral power output lines, a test magnetic coil, a neutral magnetic coil, a first electronic switch, and a first rectifier DC power unit comprising a bridge rectifier and a filter circuit. A leakage signal detection circuit may comprise a leakage signal amplification integrated circuit as its core component. An electromagnetic tripping mechanism may work under the control of the leakage signal detection circuit. The electromagnetic tripping mechanism may comprise an electromagnetic coil. A self-detection control circuit may comprise a second rectifier DC power unit, an analog leakage circuit comprising a series branch circuit comprising a first current-limiting resistor and a second electronic switch, and a micro-processing circuit composed of a microcontroller as its core component. The circuit may also comprise a self-detection alarming circuit.

### CROSS-REFERENCE TO RELATED APPLICATION

This application claims priority to and incorporates herein Chinese application No. 201310094717.2 filed on Mar. 22, 2013.

### TECHNICAL FIELD

The present disclosure relates to a low-voltage leakage protector, and in particular to a breaker circuit with failure self-detection functions.

### BACKGROUND

A socket-type ground failure circuit breaker not only can supply power to loads through the jacks of an upper cover, but also can supply power through a loader connector component to the loads connected to the loader connector component. The socket-type ground failure circuit breaker typically comprises a base, an upper cover with jacks, a leakage signal detection circuit, and an electromagnetic tripping mechanism working under the control of the leakage signal detection circuit, a reset button, a test button, a ground component, a power input connector component, and a loader connector component, wherein the leakage signal detection circuit uses an leakage signal amplification integrated circuit, such as a RV4145, as the core component, and uses a bridge rectifier and a filter circuit to supply DC power to the leakage signal amplification integrated circuit; the AC side of the bridge rectifier is connected to the power input L, N; one end of the electromagnetic tripping coil of the electromagnetic tripping mechanism is connected to the power input line L, and the other end is connected to an electronic switch element, such as the anode of a one-way SCR, and is connected to the other power input line N through the SCR rectifier and the bridge rectifier, the SCR cathode is connected to the DC negative electrode of the first rectifier circuit; both of the power supply lines L, N pass through a test magnetic coil and a neutral magnetic coil, the output ports of the test magnetic coil and the neutral magnetic coils are connected to the input port of the leakage signal amplification integrated circuit; the leakage signal will be amplified and compared by the internal circuit of the amplification integrated circuit, and when larger than the threshold settings, the leakage signal will control the output port to output a trigger signal, which is connected to the trigger terminal of the SCR, and when the leakage signal is detected by the leakage signal amplification integrated circuit, the control output port of the leakage signal amplification integrated circuit will output high level to the trigger terminal of the SCR to render it into a conducting state, the electromagnetic trip coil will be energized so that the magnetic trip mechanism will be disengaged, and the power output will be disconnected, so as to achieve the purpose of protection. After years of development, GFCI has reached higher levels either on the product quality or the technical requirements and meeting the use requirements. There are however still some other deficiencies. That is to say, in order to verify whether the circuit breaker can normally detect the leakage signal and provide timely protection actions, all open circuit protector devices are provided with test buttons, and the users are required to press the test buttons periodically to detect whether the circuit breaker of the protector device works properly. Yet in practice, a larger part of users will not be able to periodically manually press the test buttons to carry out the examinations as required, and once the open circuit protector device is damaged and not replaced timely, it will cause electrical safety accidents, and therefore there are security risks.

### SUMMARY

The object of the present disclosure is to overcome the deficiencies of the prior art and provide a safe and reliable breaker circuit with failure self-detection functions.

The present disclosure relates to a breaker circuit with failure self-detection functions, comprising a leakage signal detection circuit, and an electromagnetic tripping mechanism working under the control of the leakage signal detection circuit, a self-detection control circuit, and a self-detection alarming circuit, the self-detection control circuit comprising a second rectifier DC power supply, an analog leakage circuit, and a micro-processing circuit composed of a microcontroller as the core component. In this disclosure, due to the addition of the self-detection control circuit and the self-detection alarming circuit with the micro-processing circuit as the core component, the micro-processing circuit may output control signals through the respective data output port, so that the analog leakage circuit can be connected, generating analog leakage signals, while monitoring the output of the leakage signal amplification integrated circuit, determining whether there is abnormal in the circuit, and controlling the self-detection alarming circuit to send alarming signals if there is. The micro-processing circuit may periodically carry out the above examinations by program settings to achieve periodical automatic examinations, and eliminate the potential safety problems due to incapability of the users to periodically carry out the required examinations.

In order to achieve the above object, the present disclosure provides a breaker circuit with failure self-detection functions. The circuit may comprise line and neutral power supply lines, line and neutral power output lines, a test magnetic coil, a neutral magnetic coil, a first electronic switch, and a first rectifier DC power unit comprising a bridge rectifier and a filter circuit. A leakage signal detection circuit may comprise a leakage signal amplification integrated circuit as its core component. An electromagnetic tripping mechanism may work under the control of the leakage signal detection circuit. The electromagnetic tripping mechanism may comprise an electromagnetic coil. A self-detection control circuit may comprise a second rectifier DC power unit, an analog leakage circuit comprising a series branch circuit comprising a first current-limiting resistor and a second electronic switch, and a micro-processing circuit composed of a microcontroller as its core component. The circuit may also comprise a self-detection alarming circuit.

The first rectifier DC power unit supplies DC power to the leakage signal amplification integrated circuit. An AC side of the bridge rectifier is connected to the line and neutral power supply lines. One end of the electromagnetic tripping coil is connected to the line and neutral power supply lines after being connected to the first electronic switch in series. The line and neutral power supply lines pass through the test magnetic coil and the neutral magnetic coil. An output port of the test magnetic coil and an output port of the neutral magnetic coil are connected to at least one port of the leakage signal amplification integrated circuit. The second rectifier DC power unit exclusively supplies power to the micro-processing circuit. A first end of the analog leakage circuit is connected to the line power supply line and a second end of the analog leakage circuit is connected to the neutral power output line.

A first output of the leakage signal amplification integrated circuit is connected to output data to a first data input port of the micro-processing circuit through a first switch triode transistor circuit. A first data output port of the micro-processing circuit is connected to a control terminal of the first electronic switch. A second data output port of the micro-processing circuit is connected to the second electronic switch to control the connection and disconnection of the analog leakage circuit. A third data output port of the micro-processing circuit controls the self-detection alarming circuit.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate the embodiments of the present disclosure and together with the description, serve to explain the principles of the invention.

FIG. 1 is a schematic diagram of an electronic circuit according to a particular embodiment.

FIG. 2 is a schematic diagram of an electronic circuit according to another embodiment.

FIG. 3 is an explanatory flow diagram of the electronic circuit.

### DETAILED DESCRIPTION

References will now be made in detail to the present exemplary embodiments, examples of which are illustrated in the accompanying drawings. Wherever possible, the same reference numbers will be used throughout the drawings to refer to the same or like parts. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

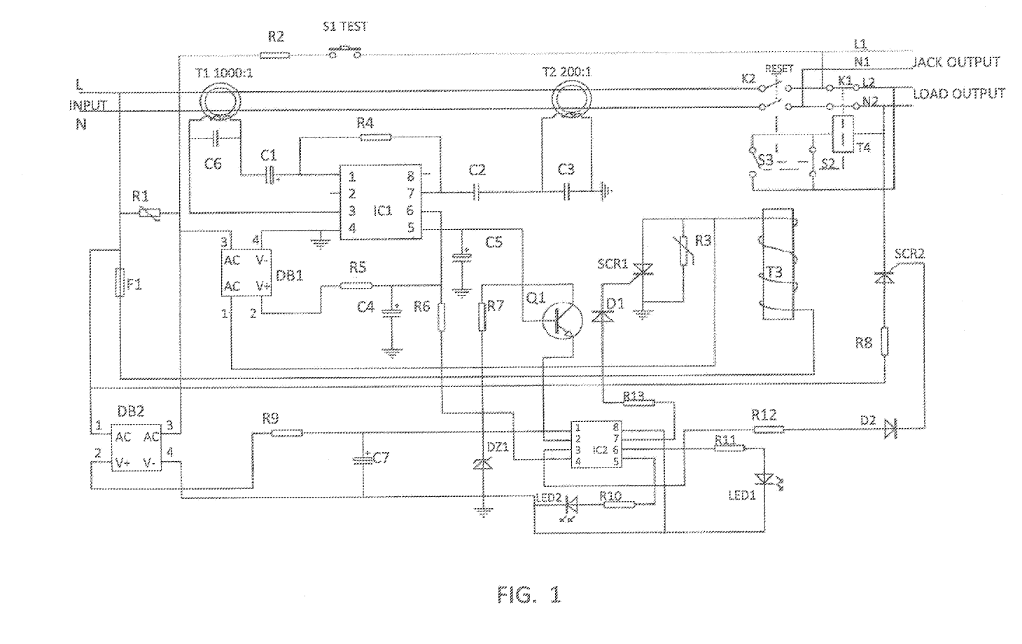

As shown in FIG. 1, a breaker circuit with failure self-detection functions comprises a leakage signal detection circuit and an electromagnetic tripping mechanism working under the control of the leakage signal detection circuit, a rectifier DC power supply unit, an alarming circuit, and a self-detection control circuit. In the breaker circuit, the leakage signal detection circuit uses a leakage signal amplification integrated circuit IC1 RV4145 as the core component. It can also use other similar integrated circuits, such as LM1851, KA2807, or GK4141 integrated circuits. A full-wave rectifier DB1, a resistor R5, and a capacitor C4 are configured into a first rectifier DC power supply unit and a RC filter circuit for supplying DC power to the RV4145. The AC side of the full-wave rectifier DB1 is connected to the power input lines L, N. The other ends of the power input lines L, N will be used as the power supplies L1, N1 (jack output) and L2, N2 (terminal output) via the contact components K1, K2. Both of the power lines L1, N1 pass through a test magnetic coil T1 and a neutral magnetic coil T2. The test magnetic coil T1 is connected to the leakage signal amplification integrated RV4145. One end of the neutral magnetic coil T2 is connected to the input port of the operation amplifier of the leakage signal amplification integrated RV4145 via a capacitor C2. One end of the electromagnetic tripping coil in the electromagnetic tripping mechanism is connected into the power supply after being connected to a first electronic switch in series. The first electronic switch may have many choices, such as a switching triode transistor, SCR (silicon controlled rectifier, or thyristor), and the like. In this particular embodiment, the first electronic switch uses a one-way SCR to act as the one-way tripping SCR SCR1. One end of the tripping coil T3 in the electromagnetic tripping mechanism is connected to the anode of the one-way tripping SCR SCR1. The cathode of the one-way tripping SCR SCR1 is connected to the negative electrode of the first rectifier DC power unit. In order to ensure the long-term stability of the self-detection control circuit, the present disclosure provides a separate power supply for the automatic detection circuit, so that the automatic detection function is not affected due to the failure of the power supply circuit of the breaker. The self-detection control circuit therefore comprises a second rectifier DC power supply unit, an analog leakage circuit, and a micro-processing circuit composed of a microcontroller IC2 as the core component. The second rectifier DC power supply unit will supply power to the micro-processing circuit separately. A full-wave rectifier DB2, a resistor R9, a capacitor C7, and a voltage regulating circuit are configured into the second rectifier DC power supply unit. The AC port of the full-wave rectifier DB2 is connected to the power input line L, N. The output port of the full-wave rectifier DB2 is connected to the current-limiting resistor R9 and is input to the voltage regulating circuit through the filter circuit of the C7. As shown in FIG. 1, the voltage regulating circuit may be a three-terminal regulating integration, and may also be a voltage regulating diode or other voltage regulating modules.

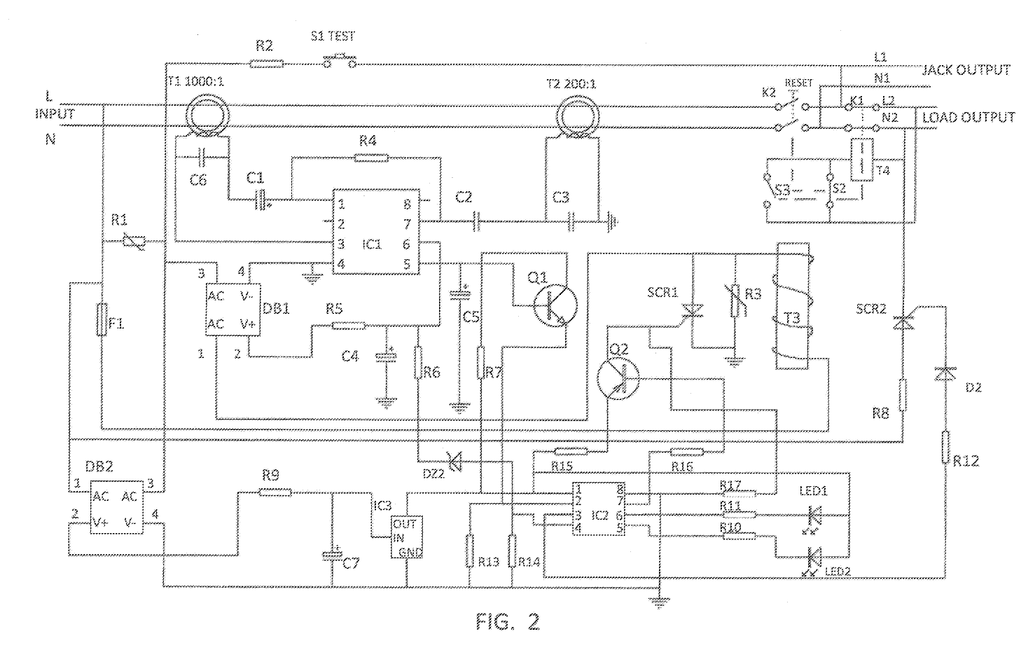

And as shown in FIG. 2, the voltage regulating circuit may also use the three-terminal regulating integration. After its voltage output has been regulated, the DC power supply is connected to the power supply terminal of the microcontroller IC2 to supply power to the micro-processing circuit separately. The analog leakage circuit is composed of a series branch circuit of a second current-limiting resistor R8 and a second electronic switch. The second electronic switch may also have many choices as well, such as a switching triode transistor, a SCR, and the like. In this particular embodiment, the second electronic switch may also selectively use a one-way SCR to act as the one-way test tripping SCR SCR2. Both ends of the analog leakage circuit are connected to the L and N2 terminals of the AC input and output ports of the circuit breaker, respectively. The output of the leakage signal amplification integrated circuit IC1 is connected to the first data input port of the micro-processing circuit composed of the microcontroller IC2 as the core component through a resistor R6 and a regulator diode DZ2. The regulated value of the regulator diode DZ2 is chosen to be slightly 5˜10 V lower than that of the first rectifier DC power supply. The first data output port of the micro-processing circuit is connected to the control terminal of the first electronic switch, i.e., the trigger terminal of the one-way test SCR SCR1, to control the action of the electromagnetic tripping circuit. The second data output port of the micro-processing circuit is connected to the second electronic switch, i.e., the trigger terminal of the one-way test SCR SCR2, to control the connection and disconnection of the analog leakage circuit. In order to prevent high voltage power supply from affecting the microcontroller IC2, in this particular embodiment, the first data output port of the micro-processing circuit is connected to the trigger terminal of the one-way tripping SCR SCR1 after passing a first pull-down resistor R13 and a second switching triode transistor Q2, the second electronic switch is composed of the one-way test SCR SCR2. The second data output port of the micro-processing circuit is connected to the trigger terminal of the one-way test SCR SCR2 after passing a third current-limiting resistor R12 and a blocking diode D2. In order to amplify the output signal from the leakage signal amplification integrated circuit and make its output level match that of the microcontroller IC2, in this particular embodiment, the output of the leakage signal amplification integrated circuit IC1 is connected to the base of the first amplifier triode transistor Q1. The collector of the first amplifier triode transistor Q1 is connected to the positive electrode of the second rectifier DC power supply unit through a resistor R7. And its emitter is connected to the first data input port of the micro-processing circuit composed of the microcontroller IC2 as the core component to carry out the signal amplification and level shifting. The second data input (pin 4) of the micro-processing microcontroller IC2 is connected to the power supply terminal (pin 6) of the leakage signal amplification integrated circuit, so as to sample the voltage of the power supply terminal of the leakage signal amplification integrated circuit. The self-detection alarming circuit is composed of a first light emitting diode LED2 and a fourth current-limiting resistor R10 connected in series. The self-detection alarming circuit is connected to the third data input port (pin 5) of the micro-processing circuit and the positive electrode of the second rectifier DC power supply unit. In order to send alarming signals even when there are failures in the internal components, in the breaker circuit with failure self-detection functions there is further provided with an end-of-life alarming circuit, which is composed of a second light-emitting diode LED1 and a fifth limit resistor R11 in series, and which is connected to the fourth data input port (pin 6) of the micro-processing circuit and the positive electrode of the second rectifier DC power supply unit.

The circuit works as follows. After normal reset of the socket-type ground failure circuit breaker, when there appears leakage in the load, the 5th pin of the leakage signal amplification integrated circuits IC1 may output high level; after this high level is detected by the first data input port (pin 2) of the microcontroller IC2, the first data output port (pin 7) will output low level to trigger the one-way tripping SCR SCR1 into a conducting state; the electromagnetic tripping circuit will take action, the socket-type ground failure circuit breaker will be tripped, and the load-side will be disconnected. When a self-detection is required, under the control of internal programs, the second data output port of the micro-processing circuit microcontroller IC2 will output high level, triggering the second electronic switch, i.e. the one-way test SCR SCR2, into a conducting state, commanding the connection of the analog leakage circuit to simulate a leakage failure; in the meanwhile the first data input port (pin 2) of the microcontroller IC2 monitors the output of the leakage signal amplification integrated circuit; if the leakage control signal (high level) is received from the leakage signal amplification integrated circuit IC1, it means that the leakage signal detection circuit is normal, and if no such signals is received (low level is maintained), it means that the leakage signal detection circuit is abnormal, the third output port (pin 5) of the micro-processing circuit microcontroller IC2 will output low level, and the first light emitting diode LED2 will be turned on to send alarming signals. The micro-processing circuit may further carry out the above examinations periodically by program settings to achieve periodical automatic examinations, which eliminates the potential safety problems of the current breakers due to the incapability of the users to periodically carry out the required examinations.

In addition, if any element (such as the full-wave rectifier DB1, the resistor R5, the capacitor C4, the trip coil T3, or the leakage signal amplifier integrated circuits IC1) of the breaker circuit is damaged to cause the voltage change of the power supply of the leakage signal amplification integrated circuit IC1, after the second data input port (pin 4) of the micro-processing circuit microcontroller IC2 discovers the change through sampling, the third data input port (pin 5) of the micro-processing circuit microcontroller IC2 will output low level, and the first light emitting diode LED2 will be turned on to send alarming signals.

If there are no damages to the elements in the breaker circuit, the voltage of the power supply of the leakage signal amplification integrated circuit IC1 is normal, the voltage will be input to the second data input port (pin 4) of the micro-processing circuit microcontroller IC2 after the breakdown of the regulator diode DZ2 so as to decrease the voltage; after the internal processing of the micro-processing circuit microcontroller IC2 determines that the sampled high level is normal, the fourth data input port (pin 6) of the micro-processing circuit microcontroller IC2 will output low level, and the second light emitting diode LED1 will be turned on to indicate that there is no failure in the circuit breaker and it can be normally used.

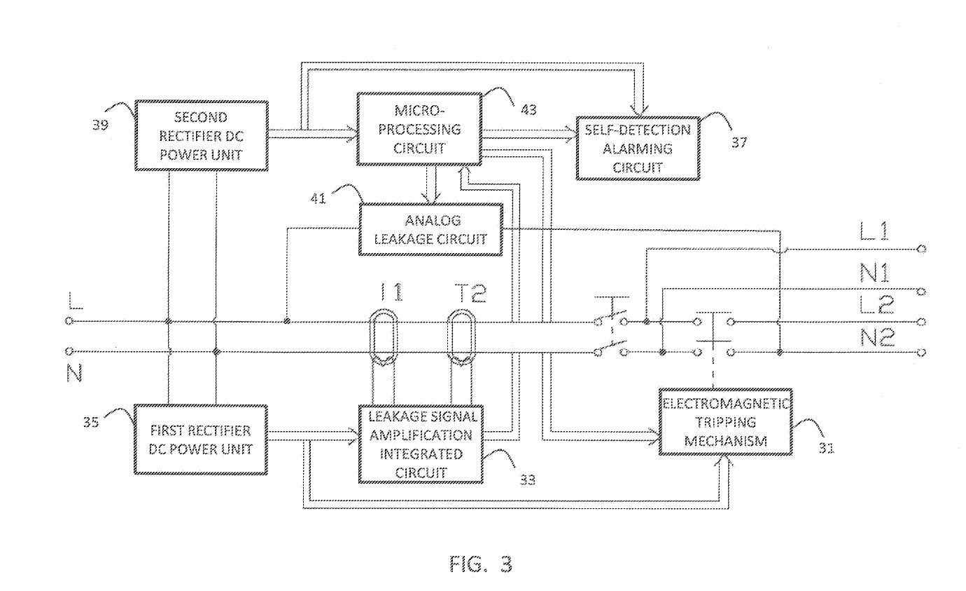

Turning to the simplified representation of FIG. 3, a breaker circuit with failure self-detection functions comprises, on the bottom half, a leakage signal detection circuit and an electromagnetic tripping mechanism 31 working under the control of the leakage signal detection circuit. The leakage signal detection circuit uses a leakage signal amplification integrated circuit 33 as the core component, and uses a first rectifier DC power unit 35 composed of a bridge rectifier and a filter circuit to supply DC power to the leakage signal amplification integrated circuit 33. An AC side of the bridge rectifier is connected to the power input L, N. One end of the electromagnetic tripping coil of the electromagnetic tripping mechanism 31 is connected into the power supply after being connected to a first electronic switch element in series. Both of the power supply lines L, N pass through a test magnetic coil T1 and a neutral magnetic coil T2. The output ports of the test magnetic coil T1 and the neutral magnetic coils T2 are connected to the input port of the leakage signal amplification integrated circuit 33.

The breaker circuit is further provided, on the top half of FIG. 3, with a self-detection control circuit and a self-detection alarming circuit 37. The self-detection control circuit comprises a second rectifier DC power supply unit 39, an analog leakage circuit 41, and a micro-processing circuit 43 composed of a microcontroller as the core component. The second rectifier DC power supply unit will separately supply power to the micro-processing circuit 43. The analog leakage circuit 41 comprises a series branch circuit of a second current-limiting resistor and a second electronic switch. Respective ends of the analog leakage circuit are connected to the L or N line of the AC input and the L or N line of the AC output end of the breaker. As illustrated, a first end of the analog leakage circuit 41 is connected to the L line of the AC input and the other end of the analog leakage circuit is connected to the N line of the AC output.

The output of the leakage signal amplification integrated circuit 33 is connected to the first data input port of the micro-processing circuit 43, which is connected to the control terminal of the first electronic switch to control the action of the electromagnetic tripping circuit 31. The second data output port of the micro-processing circuit 43 is connected to the second electronic switch to control the connection and disconnection of the analog leakage circuit 41. And, the third data output port of the micro-processing circuit 43 controls the self-detection alarming circuit 37.

Due to the addition of the self-detection control circuit and the self-detection alarming circuit 37 using the micro-processing circuit 43 as the core component, the micro-processing circuit 43 can output control signals through the corresponding data output port so that the analog leakage circuit 41 will be connected, generating analog leakage signals. In the meanwhile, the output of the leakage signal amplification integrated circuit 33 is monitored, and if a leakage control signal (high level) is received from the leakage signal amplification integrated circuit 33, it means that the leakage signal detection circuit is normal. If no such signal is received (low level is maintained), it means that the leakage signal detection circuit 33 is abnormal, and the micro-processing circuit 43 will output signals to control the self-detection alarming circuit 37 to send alarming signals. The micro-processing circuit 43 can also periodically carry out the above examinations by program settings to achieve periodic automatic examinations and eliminate the potential safety problems of the current breaker due to the incapability of the users to periodically carry out the required examinations.

In the preceding specification, various preferred embodiments have been described with reference to the accompanying drawings. It will, however, be evident that various other modifications and changes may be made thereto, and additional embodiments may also be implemented, without departing from the broader scope of the invention as set forth in the claims that follow.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. A breaker circuit with failure self-detection functions, comprising:
line and neutral power supply lines;
line and neutral power output lines;
a test magnetic coil;
a neutral magnetic coil;
a first electronic switch;
a first rectifier DC power unit comprising a bridge rectifier and a filter circuit;
a leakage signal detection circuit comprising a leakage signal amplification integrated circuit as its core component;
an electromagnetic tripping mechanism working under the control of the leakage signal detection circuit, the electromagnetic tripping mechanism comprising an electromagnetic coil;
a self-detection control circuit comprising:
a second rectifier DC power unit;
an analog leakage circuit comprising a series branch circuit comprising a first current-limiting resistor and a second electronic switch; and
a micro-processing circuit composed of a microcontroller as its core component; and
a self-detection alarming circuit,
wherein:
the first rectifier DC power unit supplies DC power to the leakage signal amplification integrated circuit,
an AC side of the bridge rectifier is connected to the line and neutral power supply lines,
one end of the electromagnetic tripping coil is connected to the line and neutral power supply lines after being connected to the first electronic switch in series,
the line and neutral power supply lines pass through the test magnetic coil and the neutral magnetic coil,
an output port of the test magnetic coil and an output port of the neutral magnetic coil are connected to at least one port of the leakage signal amplification integrated circuit,
the second rectifier DC power unit exclusively supplies power to the micro-processing circuit,
a first end of the analog leakage circuit is connected to the line power supply line and a second end of the analog leakage circuit is connected to the neutral power output line,
a first output of the leakage signal amplification integrated circuit is connected to output data to a first data input port of the micro-processing circuit through a first switch triode transistor circuit,
a first data output port of the micro-processing circuit is connected to a control terminal of the first electronic switch,
a second data output port of the micro-processing circuit is connected to the second electronic switch to control the connection and disconnection of the analog leakage circuit, and
a third data output port of the micro-processing circuit controls the self-detection alarming circuit.

2. The breaker circuit of claim 1, wherein:
the first electronic switch comprises a one-way tripping silicon controlled rectifier (“SCR”), and the one-way tripping SCR comprises an anode, a cathode and a trigger terminal,
one end of the electromagnetic tripping coil is connected to the line power supply line,
a second end of the electromagnetic tripping coil is connected to the neutral power supply line through the anode of the one-way tripping SCR and a rectifier bridge,
the cathode of the one-way tripping SCR is connected to a DC negative electrode,
the first data output port of the micro-processing circuit is connected to the trigger terminal of the one-way tripping SCR to control the action of the electromagnetic tripping circuit,
the second electronic switch comprises a one-way test SCR, and the second data output port of the micro-processing circuit is connected to a trigger terminal of the one-way test SCR to control the connection and disconnection of the analog leakage circuit.

3. The breaker circuit of claim 2, wherein the first data output port of the micro-processing circuit is connected to the trigger terminal of the one-way tripping SCR through a second current-limiting resistor and a third electronic switch.

4. The breaker circuit of claim 2, wherein the second electronic switch is composed of the one-way test SCR, and the second data output port of the micro-processing circuit is connected to the trigger terminal of the one-way test SCR through a third current-limiting resistor and a blocking diode.

5. The breaker circuit of claim 1, further comprising a first amplifier triode transistor connected receive an output of the leakage signal amplification integrated circuit and further configured to amplify and level shift the output of the leakage signal amplification integrated circuit and to output the amplified and shifted signal to the first data input port of the micro-processing circuit.

6. The breaker circuit of claim 1, wherein the second data input port of the micro-processing circuit is connected to a power supply terminal of the leakage signal amplification integrated circuit to sample a voltage of the power supply terminal of the leakage signal amplification integrated circuit.

7. The breaker circuit of claim 1, wherein the self-detection alarming circuit comprises a first light emitting diode and a fourth current-limiting resistor connected in series, and the self-detection alarming circuit is connected to the third data output port of the micro-processing circuit and a positive electrode of the second rectifier DC power unit.

8. The breaker circuit of claim 1, further comprising an end-of-life alarming circuit comprising a second light emitting diode and a fifth current-limiting resistor connected in series, wherein the end-of-life alarming circuit is connected to a fourth data output port of the micro-processing circuit and a positive electrode of the second rectifier DC power supply unit.

9. The breaker circuit of claim 1, wherein the second rectifier DC power unit comprises a full-wave rectifier, a filter capacitor, and a voltage regulating circuit, and wherein the voltage regulating circuit is one of a three-terminal regulator integration or a voltage regulator diode.

10. The breaker circuit of claim 1, wherein the second rectifier DC power supply unit is composed of a full-wave rectifier, a filter capacitor, and a voltage regulating circuit.

11. The breaker circuit of claim 1, further comprising a second switch triode transistor circuit, wherein the first data input port of the micro-processing circuit is connected to the control terminal of the first electronic switch through the second switch triode transistor circuit to control the action of the electromagnetic tripping circuit.

12. The breaker circuit of claim 1, wherein the first data output port of the micro-processing circuit is connected to the control terminal of the first electronic switch through a second switch triode transistor circuit to control the action of the electromagnetic tripping circuit.
